(19) United States
(12) Patent Application Publication
(10) Pub. No.: US 2026/0194885 A1
(43) Pub. Date: Jul. 9, 2026

(54) FACILITY EMISSIONS SYSTEM

(71) Applicant: Schlumberger Technology Corporation, Sugar Land, TX (US)

(72) Inventors: Weijia Du, Cambridge (GB); Sai Venkatakrishnan Sankaranarayanan, Cambridge (GB); Timothy Wade Okabayashi, Cambridge (GB); Kananben Patel, Houston, TX (US); Adolfo Contreras Ruiz Esparza, Mexico City (MX)

(21) Appl. No.: 19/398,445

(22) Filed: Nov. 24, 2025

Related U.S. Application Data
(60) Provisional application No. 63/724,361, filed on Nov. 24, 2024.

(51) Int. Cl. G05B 19/418

(52) U.S. Cl. CPC G05B 19/41835; G05B 2219/41108

(57) ABSTRACT

A method can include acquiring sensor data from a facility; quantifying greenhouse gas emissions from equipment components at the facility; determining uncertainty for the greenhouse gas emissions from the equipment components; and issuing a control instruction to the facility to reduce the greenhouse gas emissions or to reduce the uncertainty.

### CROSS-REFERENCE TO RELATED APPLICATION(S)

The present disclosure claims priority from U.S. Prov. Patent Appl. No. 63/724,361, filed on Nov. 24, 2024, herein incorporated by reference in its entirety.

### BACKGROUND

A reservoir can be a subsurface formation that can be characterized at least in part by its rock properties such as porosity and permeability, and fluid properties such as viscosity and compressibility. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.). Various operations may be performed in the field to access, produce, transport, process, etc., such hydrocarbon fluids. As an example, a field may include a number of facilities, which may be isolated, in fluid communication, etc. As an example, fluid communication may be via a reservoir and/or via a fluid network (e.g., pipes, etc.). As an example, emissions such as greenhouse gas emissions may occur during one or more operations at one or more facilities. In various instances, monitoring emissions may be challenging, particularly where unavailability and/or uncertainty exists with respect to measurement devices, emission duration, frequency, etc.

### SUMMARY

A method may include acquiring sensor data from a facility; quantifying greenhouse gas emissions from equipment components at the facility; determining uncertainty for the greenhouse gas emissions from the equipment components; and issuing a control instruction to the facility to reduce the greenhouse gas emissions or to reduce the uncertainty. A system may include a processor; a memory accessible to the processor; and processor-executable instructions stored in the memory to instruct the system to: acquire sensor data from a facility; quantify greenhouse gas emissions from equipment components at the facility; determine uncertainty for the greenhouse gas emissions from the equipment components; and issue a control instruction to the facility to reduce the greenhouse gas emissions or to reduce the uncertainty. One or more computer-readable storage media may include processor-executable instructions to instruct a wellsite computing system to: acquire sensor data from a facility; quantify greenhouse gas emissions from equipment components at the facility; determine uncertainty for the greenhouse gas emissions from the equipment components; and issue a control instruction to the facility to reduce the greenhouse gas emissions or to reduce the uncertainty. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates examples of equipment, an example of a network and an example of a system;

FIG. 3 illustrates an example of a system;

FIG. 4 illustrates an example of a system;

FIG. 5 illustrates an example of a workflow;

FIG. 6 illustrates an example of a workflow;

FIG. 7 illustrates graphics of examples of emissions sources;

FIG. 8 illustrates an example of a workflow;

FIG. 9 illustrates an example of a technique for assessing weather;

FIG. 10 illustrates an example of a technique for assessing weather;

FIG. 11 illustrates an example of a graphic of a hierarchy;

FIG. 12 illustrates an example of a workflow;

FIG. 13 illustrates an example of a workflow;

FIG. 14 illustrates an example of a method and an example of a system; and

FIG. 15 illustrates examples of computer and network equipment.

### DETAILED DESCRIPTION

This description is not to be taken in a limiting sense, but rather is made merely for the purpose of describing the general principles of the implementations. The scope of the described implementations should be ascertained with reference to the issued claims.

### Example System

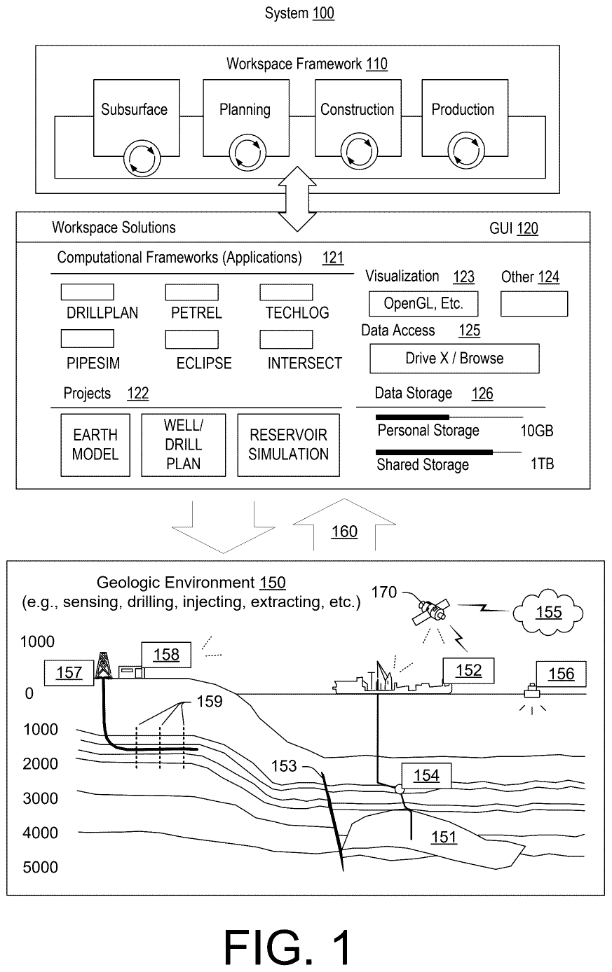

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). As an example, such an environment can provide for operations that involve one or more frameworks. The DELFI environment may be referred to as the DELFI framework, which may be a framework of frameworks. As an example, the DELFI environment can include various other frameworks, which can include, for example, one or more types of models (e.g., simulation models, etc.).

The TECHLOG framework can handle and process field and laboratory data for a variety of geologic environments (e.g., deepwater exploration, shale, etc.). The TECHLOG framework can structure wellbore data for analyses, planning, etc.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.). While several simulators are illustrated in the example of FIG. 1, one or more other simulators may be utilized, additionally or alternatively.

In the example of FIG. 1, the visualization features 123 may be implemented via the workspace framework 110, for example, to perform tasks as associated with one or more of subsurface regions, planning operations, constructing wells and/or surface fluid networks, injecting fluid into a reservoir, and producing fluid from a reservoir.

### Example Geologic Environment

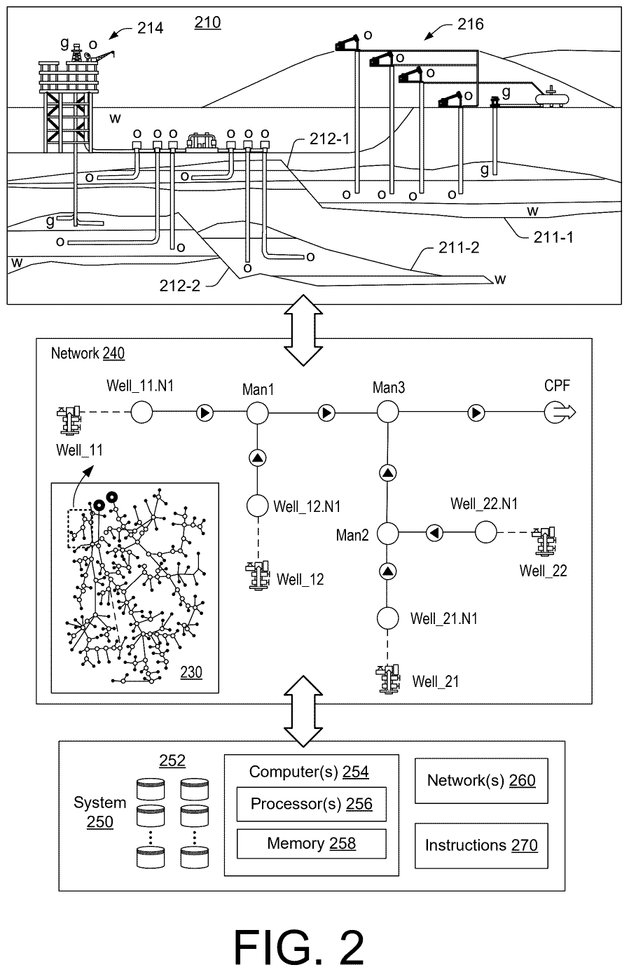

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1. In the example of FIG. 2, the geologic environment 210 can include fluids such as oil (o), water (w) and gas (g), which may be stratified in the reservoirs 211-1 and 211-2.

In the example of FIG. 2, the equipment 214 and 216 can include one or more of drilling equipment, wireline equipment, production equipment, etc. For example, consider the equipment 214 as including a drilling rig that can drill into a formation to reach a reservoir target where a well can be completed for production of hydrocarbons. As an example, the equipment 216 can include production equipment such as wellheads, valves, pump equipment, gas handling equipment, etc. As an example, one or more features of the system 100 of FIG. 1 may be utilized for operations in the geologic environment 210. For example, consider utilizing a drilling or well plan framework, a drilling execution framework, a production framework, etc., to plan, execute, etc., one or more drilling operations, production operations, etc.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of fluid (e.g., oil, water and/or gas) from well locations along flowlines interconnected at junctions with final delivery at a central processing facility (CPF). Where fluid includes solids (e.g., sand, etc.), one or more pieces of equipment may provide for solids removal, collection, etc.

In the example of FIG. 2, various portions of the network 240 may include conduit. For example, consider a perspective view of a geologic environment that includes two conduits which may be a conduit to Man1 and a conduit to Man3 in the network 240, where Man1, Man2 and Man3 are manifolds.

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors.

As an example, the instructions 270 can include instructions (e.g., stored in the memory 258) executable by at least one of the one or more processors 256 to instruct the system 250 to perform various actions.

As an example, various graphics in FIG. 2 may be part of a graphical user interface (GUI) that can be generated using executable instructions that may be executable locally and/or remotely using local and/or remote display devices (e.g., a mobile device, a workstation, etc.).

In various scenarios, one or more pumps may be utilized to inject fluid into a reservoir and/or to produce fluid from a reservoir. For example, consider artificial-lift technology that may be utilized for movement of fluid. While the term lift is utilized, various artificial-technologies may be operated in a manner to move fluid downhole or to lift fluid uphole. For example, various electric submersible pumps (ESP) may be operable in a lift-mode or in an inject-mode.

### Example Systems

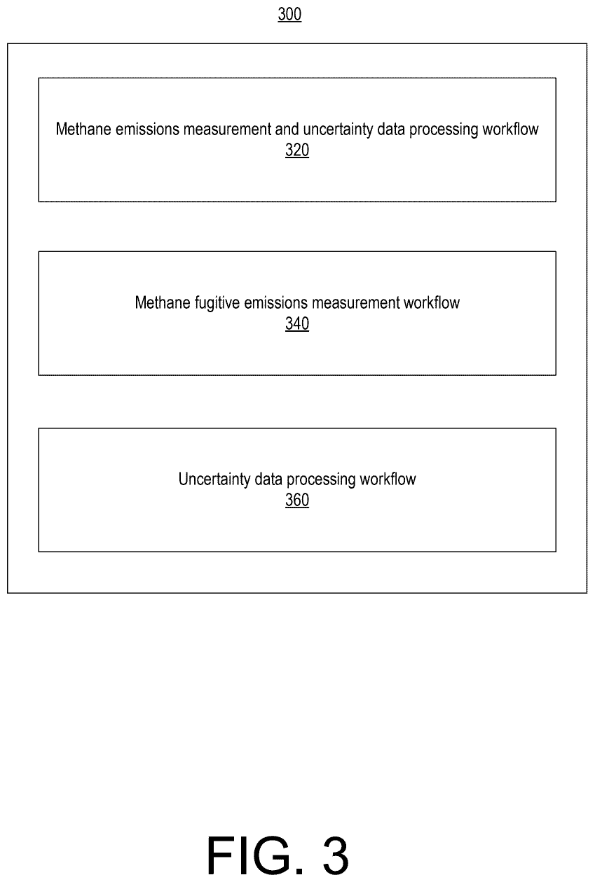

FIG. 3 shows an example of a system 300 with various components such as, for example, a methane emissions measurement and uncertainty data processing workflow component 320, a methane fugitive emission measurement workflow component 340, and an uncertainty data processing workflow component 360.

As an example, the system 300 may provide for computing methane emissions in the oil and gas industry and quantifying uncertainties in methane emissions computations. As explained, the system 300 may provide for a comprehensive methane emission monitoring and/or control. As explained, a system may provide for methane emission measurement and uncertainty data processing, methane fugitive emission measurement (e.g., for oil and gas facilities, etc.), and uncertainty data processing.

As an example, a system may provide for compliance, reporting, etc., with one or more climate and clean air coalitions (CCACs) such as, for example, the Oil & Gas Methane Partnership 2.0 (OGMP 2.0) of the United Nations Environment Programme. The OGMP 2.0 is an oil and gas reporting and mitigation program that calls for comprehensive, measurement-based reporting for the oil and gas industry with an aim to improve accuracy and transparency of methane emissions reporting. Such reporting may provide for prioritizing methane mitigation actions. The OGMP 2.0 aims to provide for standardized measurement and reporting such that mitigation opportunities and actions may be appropriately identified and implemented. As a multi-partner program, the OGMP 2.0 aims to provide for tracking and comparing progress and performance across different entities.

An aspect of the OGMP 2.0 is the International Methane Emissions Observatory (IMEO) approach to a so-called methane data problem. The IMEO is an initiative that drives action on methane reduction and involves generation of a database of empirically verified methane emissions. The IMEO approach involves collection and reconciliation of data from multiple sources, including entity reporting, for example, through one or more of the OGMP 2.0, satellites, scientific methane measurement studies, national inventories, etc.

In turn, the IMEO, as an entity, is an implementing partner of the Global Methane Pledge, an EU-US-led effort gathering over 150 countries to reduce global methane emissions. In this role, the IMEO incentivizes governments and companies to target strategic mitigation actions and identify science-based policy options, which may be based on a database of global scope.

The OGMP 2.0 approach categorizes emission reporting into different levels, with each level representing a different degree of precision and comprehensiveness in measuring and reporting methane emissions. These levels aim to help entities progressively improve their emissions reporting accuracy. For example, consider the following levels of reporting: Level 1 (L1) as a basic estimation using default emission factors; Level 2 (L2) as a more detailed estimations using company-specific factors; Level 3 (L3) as a direct measurement of emissions from key sources; Level 4 (L4) as a comprehensive direct measurements and detailed source-level reporting; and Level 5 (L5) as a full facility-level measurement and reconciliation with top-down assessments. As to the foregoing levels, L4 emissions reporting entails direct measurements of methane emissions from identified sources within a facility.

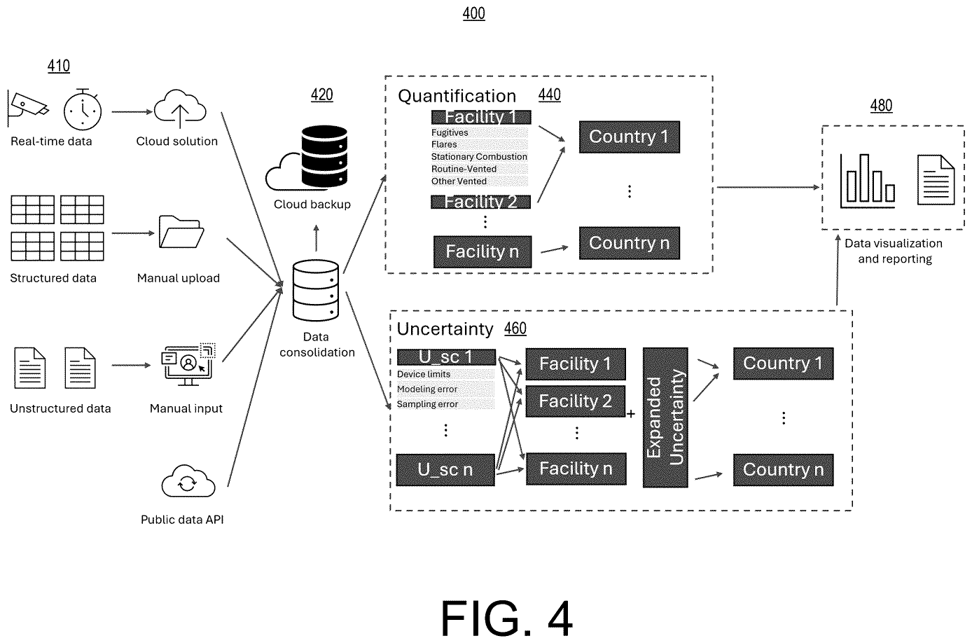

FIG. 4 shows an example of a system 400 that includes various features such as, for example, input features 410, storage features 420, computation features 440, uncertainty features 460, and output features 480 (e.g., graphics, graphical controls, interfaces, equipment controllers, etc.). As an example, the system 400 may provide for performing a methane emission measurement and uncertainty data processing digital workflow. For example, consider implementation of a methane emission acquisition protocol and emission data processing digital workflow that involves receipt of data, which can include measurement data.

As explained, L4 involves measurement data, which may include various types of data from one or more sources. For example, consider client, facility, latitude/longitude, inspection date, emission type, component, sub-source, emission rate, etc. As an example, an emission rate may be standardized to Standard Cubic Feet per Minute (SCFM) or Standard Cubic Meter per Minute (SM³/M) with a standardized temperature (288.15 Kelvin) and standard pressure/atmospheric pressure (101,325.00 Pascals). As an example, gas composition, annual throughput, flow rate variability based on the process (e.g., continuous, intermittent, emergency, routinary, etc.) may be converted to kg/h of methane based on the gas composition of gas and standard molar volume.

As an example, information provided by an entity such as, for example, details about facilities, processes etc., may be received as input. As an example, emission data on “venting—other” as well as “malfunctions/incidents” may be provided by an operator. As an example, data from “venting—other” and “malfunctions/incidents” may be reported as a single category by an entity.

As an example, a system may provide for receipt of device documentation and accuracy data. In such an example, these inputs may pertain to technical specifications and accuracy information provided by one or more manufacturers of one or more measurement devices. Such data may include calibration certificates, accuracy statements, and technical specifications detailing performance and limitations of the instruments used.

As an example, a system may provide for receipt of public data. For example, consider data that are publicly available and relevant to a measurement campaign. As to some examples, consider data such as one or more of weather data, environmental data, regulatory standards data, etc. These kinds of data may be utilized by a system in one or more workflows involving uncertainty estimation.

As an example, a system such as the system 400 may provide for data acquisition, methane quantification, uncertainty computation, data visualization, planning monitoring, reporting, controlling, etc. As an example, the system 400 may provide for implementation of a workflow for the methane emissions quantification for oil and gas facilities, which may involve monitoring, reporting, control, etc.

As an example, measurement data may be acquired from multiple measurement sources. For example, consider real-time streaming data from equipment as one source and acquired data timestamp points from a handholdable device as another source. In such an example, the real-time data may be data that are streamed from sensors, for example, as measurements from sensors that may be located at or near one or more methane emitters. As to some types of sensors, consider, for example, LIDAR devices (e.g., LIDAR cameras, etc.), flow rate meters, etc. Such types of data may be uploaded and streamed to the cloud and be consumed directly by a system during execution of a workflow. As to hand device acquired data, these data may be acquired manually from individual instances of equipment along with appropriate timestamps. These types of data may be structured using one or more types of formats. For example, consider use of one or more types of spreadsheet formats that may ease consumption (e.g., loading, etc.) by a system during execution of a workflow.

As an example, input data may be received, generated, etc., via one or more technologies, techniques, etc. For example, consider simulation, modelling, etc. As an example, physics-based models, machine learning models, hybrid models (e.g., physics-based and machine learning-based), etc., may be utilized. A model may be suitable for use with one or more simulators. As an example, a model may provide for integration of real data acquired from the field, laboratory, etc., and synthetic data. As an example, input may be based on engineering computations of thermodynamic modelling of process systems, etc. As an example, modelling, simulation, etc., may be triggered automatically responsive to receipt of field data. As an example, one or more virtual sensors may be utilized, for example, processor-based sensors that may leverage certain real data acquired in the field to provide for generation of metrics that may be normally measured by certain sensors that may not be at a field location. For example, consider a virtual flowmeter, which may be a virtual multiphase flow meter (virtual MPFM), which may be instantiated in the field locally and/or remote from the field, where, for example, values as to temperature and pressure may be inputs from field sensors that may be leveraged to determine flow rate. In various instances, an actual MPFM may be resource intensive to install, operate, maintain, etc. As such, a virtual approach may be implemented in an effort to generate suitable estimates of flow at a site or sites.

As an example, client provided data and device documentation and accuracy data may differ from project-to-project and may be structured in different ways (e.g., unstructured, structured according to one or more formats, standards, etc.). As an example, an interface may be developed for extracting particular information from these kinds of data and standardizing an input data structure to a computational workflow.

As an example, public data may be accessed using one or more technologies, techniques, etc. For example, consider utilization of one or more application programming interfaces (APIs), which may provide specifications for calls and responses. For example, consider a system that may issue an API call via an interface where the API call may be received by a server that manages one or more databases. In such an example, in response to receipt of the API call, a server may issue a query to a database to retrieve one or more entries and then transmit the one or more entries back to the system. As an example, executable code may be written in one or more languages such as, for example, a C family language, PYTHON, etc. As an example, one or more formats may be utilized (e.g., consider JSON, etc.). As an example, REST technologies and/or techniques may be employed. As an example, a system may provide for efficient data handling, which may involve issuing calls and receiving responses to such calls.

As an example, once data have been received, a system may provide for execution of a data processing and consolidation script (e.g., consider a PYTHON script, etc.). In such an example, the script may be executed and store original and processed data into a cloud platform storage back-up space. In such an example, data may be fed into a quantification workflow for processing. For example, consider processing data using one or more formulas for methane. In such an example, once methane emission results are generated, uncertainty may be computed, for example, based on uncertainty data and the methane emissions results. As an example, a system may provide for visualization, reporting, monitoring, planning, control, etc.

As to a methane emission measurement methodology for oil and gas facilities, consider an approach where total methane emissions may be computed using the following example formula:

$$Total emissions = {\sum }_{material sources} ( Level 4 emissions ) + / - uncertainty + {\sum }_{less material sources} ( Level 3 emissions ) \\ Level 4 emissions = {\sum }_{Population} Emission Factor ( EF ) x Activity Factor ( AF )$$

In the foregoing formula, the Emission Factor (EF) may pertain to methane emissions emitted per unit time per component (or combustion efficiency in the case of combustion sources); and the Activity Factor (AF) may pertain to the number of hours equipment, etc., worked; noting that it may depend, additionally or alternatively, on total annual volume of hydrocarbon produced or converged through corresponding equipment, etc. As an example, types of physical components mounted over common subsystems may utilize a common AF.

As an example, for facilities included in a sampling plan, one or more EFs for one or more leaking-components may be derived from measurement surveys. As an example, for non-leaking components (e.g., components below a detection limit of an optical gas imaging (OGI) camera, etc.), American Petroleum Institute no-leak EFs may be applied. As an example, for computation of population averaged EFs and leaking population size, connections and threaded connections may be considered as a single population. As an example, where available, operational hours and stream/process specific methane content may be utilized for computations of total emissions. As an example, for routinely vented sources, direct measurements may be performed. As an example, for flares and stationary combustion sources, combustion efficiency may be determined through direct measurements. In such an example, flared (or fuel gas in the case of stationary combustion) gas volumetric flow rate and gas composition data may be provided (e.g., by one or more entities, etc.), which may serve as AFs in one or more computations.

As an example, for facilities not included in a sampling plan, asset specific and/or source specific factors may be developed from direct measurements and may be extended to develop corresponding Level 4 emission inventory entries. As an example, where available, operational data may be applied to one or more annual emission computations.

As an example, measurements may include direct measurements and/or indirect measurements. As explained, measurements may be acquired using one or more types of devices, etc. For example, consider sensors, which may be local and/or remote. As explained, one or more types of handholdable devices may be utilized. As an example, a device may be a mobile device, which may be a controllable mobile device that may be controllable as to location using one or more technologies, techniques, etc. For example, consider one or more drones, which may be one or more of land, sea, and/or air drones. As an example, a drone may include one or more types of sensors, which may provide for maneuvering, holding stationary, sensing chemicals, sensing heat, sensing humidity, sensing light, etc. As an example, multiple drones may be utilized, which may be networked, synchronized, etc. As an example, multiple drones may provide for acquisition of data simultaneously from one or more locations, perspectives, etc. As an example, one or more drones may be utilized in a manner that depends on plume dynamics. For example, consider stacking zones in height, in lateral distance, etc., to acquire data that may be relevant to plume shape, dynamics, etc., which may consider one or more environmental factors (e.g., weather, time of day, etc.).

As an example, a system may provide for acquisition of fugitive emissions measurements and vent measurements. As an example, for one or more selected sources, leak detection may be performed using one or more OGI cameras and leak quantification may be performed using one or more hi-flow samplers.

As an example, a hi-flow sampler may be a type of direct emission rate measurement device. While downwind techniques, such as tracer-flux, or mass balance techniques, may be utilized to estimate emissions at a facility level, mitigating actions may demand detection and measurement at the component level (e.g., locally at or near a piece of field equipment, a field equipment assembly, etc.).

As an example, a process to detect one or more leaks may implement OGI or US Environmental Protection Agency (EPA) Method 21, and then subsequently quantify a leak using a hi-flow sampler or sensor (HFS). In such an example, if an HFS does not suitably work (e.g., a leak is too large), a process may resort to one or more other leak measurement approaches (e.g., in-stream anemometers, anti-static bags, etc.).

In brief, to use an HFS, an operator may loosely enclose an emission point where a blower in the HFS then draws both an entire leak and surrounding air through the HFS and across transducers which measure the concentration (% gas by volume) of the target gas species (e.g., methane or volatile organic compounds (VOCs)) and total volume of air flow. As an example, another transducer may measure background concentration of the same gas in surrounding air. As an example, mass flow of a target species may be computed from an overall mass flow, a background concentration, and an emission-point concentration.

Various instruments may be available to identify emission locations (e.g., optical gas imaging, gas sniffers, laser-based detectors, etc.), and many instruments may be able to produce an estimate of concentration of a target species in air (e.g., ppm, or ppm-m readings). In general, HFS tends to be widely accepted as a technology and technique to quantify emissions.

As explained, one or more types of tools may be used to quantify detected emissions during one or more surveys. Often, quantification of methane emissions involved use of an HFS, which tends to be accurate (e.g., +/−10%), intrinsically safe, and efficient. In some cases where sources are inaccessible, a quantitative OGI (QOGI) tablet may be used to quantify one or more leaks.

As an example, one or more techniques may be utilized to compute fugitive emissions. For example, consider an American Petroleum Institute (API, not to be confused with application programming interface) no-leak emission factors approach. The API no-leak emission factors are based on emission surveys. The quantification methodology includes bagging of selected components followed by laboratory analyses and Monte-Carlo simulations to generate the leak/no-leak emission factors based on the limit of detection of the instrument.

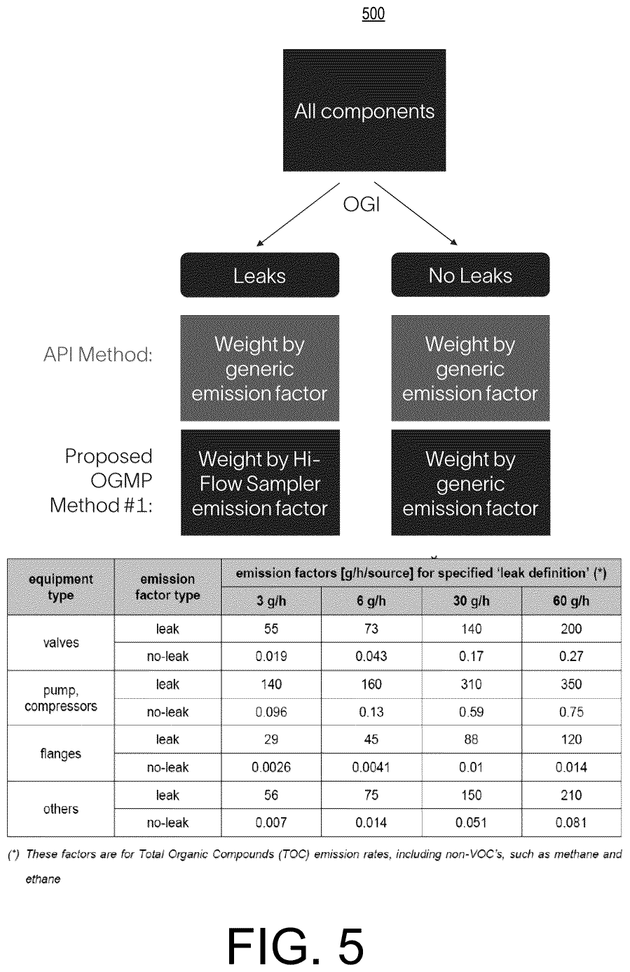

FIG. 5 shows an example workflow 500 that may utilize a leaks/no-leaks approach, which may utilize data acquired from one or more OGI instruments. As shown, various components may be measured and segregated into leak or no leak where an API technique may provide for leak weight by generic EF and no leak weight by generic EF and/or where an OGMP approach may provide for leak weight by HFS EF and no leak weight by generic EF. As an example, the workflow 500 may provide for accounting for one or more un-detected leaks.

As an example, a possible method to account for undetected emissions may be to use the API no leak EFs for undetected leaks and use HFS field measurement values for detected leaks to compute total emissions. For example, consider a system that may implement the following example equation:

$${API}_{total} = ( Detected {leaks}_{High - flow sampler} ) + ( undetected {leaks}_{API no - leak EF} )$$

In such an example, a system may compute a non-zero “no-leak” emission value for situations where no leaks are detected by a screening instrument. Further, no-leak EFs may be based on a large measurement data set. However, a disadvantage of such an approach may be that it is based on an old data set (e.g., 1970s and 1990s), which may not be representative of a current state of operation of one or more facilities.

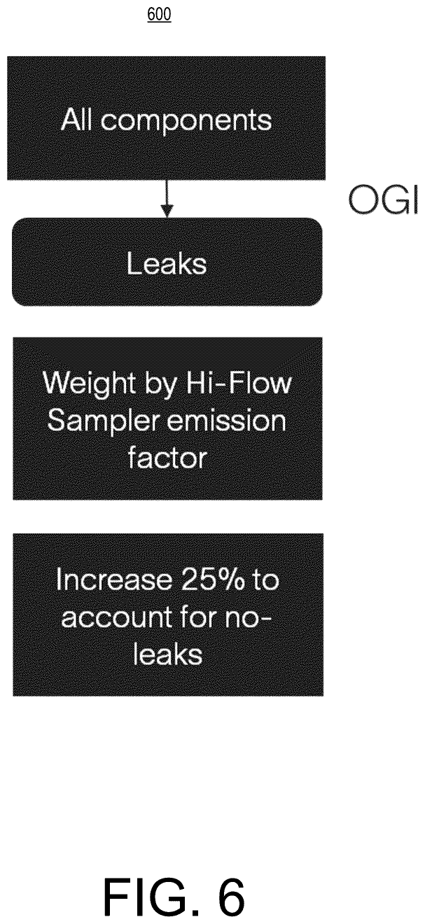

FIG. 6 shows an example workflow 600 that may be implemented by a system. Such a workflow may utilize one or more features of a US EPA proposed workflow, noted in revised subpart W. Subpart W consists of emission sources in various segments of the petroleum and natural gas industry. According to the US EPA, platforms that are subject to subpart W must submit a report for emissions from offshore petroleum and natural gas production by March 31 of each year, unless the 31st is a weekend or federal holiday, in which case the reports are due on the next business day.

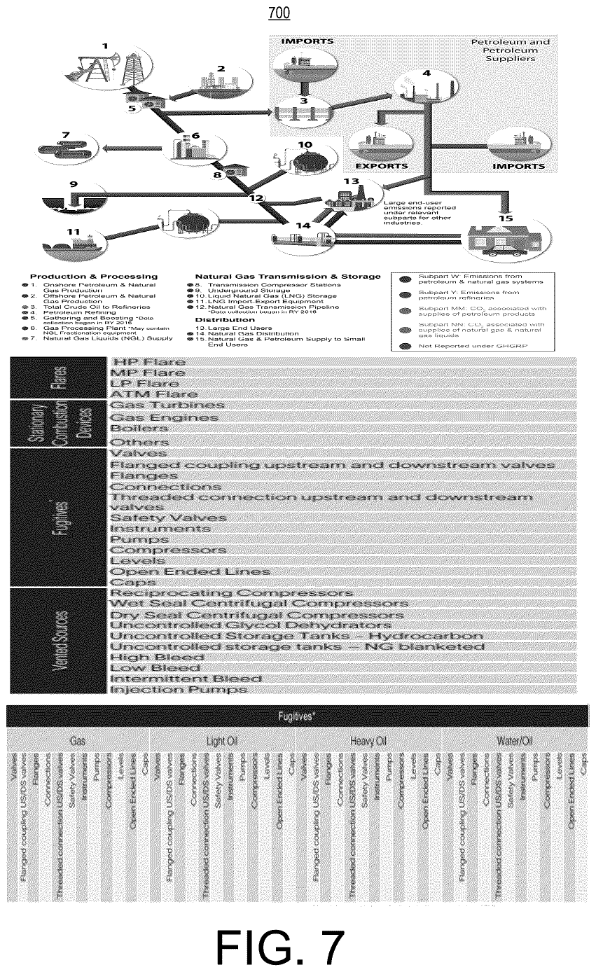

FIG. 7 shows an example schematic 700 for various emissions sources, which may include onshore petroleum and natural gas production, offshore petroleum and natural gas production, onshore natural gas processing plants, onshore natural gas transmission compression, underground natural gas storage, liquefied natural gas (LNG) storage, liquefied natural gas import and export equipment, natural gas distribution, etc.

Referring to FIG. 6, the workflow 600 may include accounting for non-detected leaks based on results from recent studies. For example, methane emission quantification projects studies found that approximately 80% of measured leaks may be detected using OGI. Thus, measured emissions may be scaled by a factor of approximately 1.25 to account for undetected leaks. For example, consider the following example equation:

$${EPA}_{total} = ( Detected {leaks}_{Hi - flow sample} ) \times 1.25$$

Such an approach may be based on the most recent comprehensive measurement data; however, it may generate a value of zero if no leaks are detected, which may be deemed unacceptable under the OGMP 2.0.

As an example, a system may implement a hybrid approach. For example, consider an approach that may report the average of two approaches (see, e.g., FIG. 5 and FIG. 6), for total fugitive emissions:

$$Total fugitive emissions = \frac{{API}_{total} + {EPA}_{total}}{2}$$

As an example, a range of the emissions may be reported as [APIₜₒₜₐₗ, EPAₜₒₜₐₗ] or [EPAₜₒₜₐₗ, APIₜₒₜₐₗ] depending on relative values. Such an approach may consider advantages and disadvantages of the two underlying approaches. For example, when no leaks are found, a hybrid approach may provide something more acceptable than stating zero emissions while also lower than the API approach. Further, listing a range in the OGMP 2.0 L4 may help with reconciliation, as appropriate.

As an example, a system may provide for generating flare combustion efficiency. For example, consider use of a Video Imaging Spectral Radiometry (VISR) camera that may be used to measure combustion efficiency of flares in scope. The VISR technique utilizes a multi-spectral mid-wave infrared imager to measure the radiance from hydrocarbons being combusted and carbon dioxide (CO2) as a complete combustion product and utilizes such data to determine combustion efficiency. Such a technique may be implemented within a continuous and autonomous remote flare monitor and/or may also be deployed as a temporary, mobile technology measurement. Despite the temporary nature of the use of a VISR camera, duration of measurement has been concluded as sufficient to capture data representative of normal operations of the flare system.

As an example, a system may provide for computing stationary combustion device combustion efficiency. For example, consider performing, on each target combustion source, a workflow that includes determining a methane slip factor (e.g., expressed in units of ng CH4/J of fuel gas on a gross heating value basis) and assessing corresponding annual methane emissions. Such a workflow may be performed through determination or measurements of composition and flowrate of fuel gas, combustion air, and exhaust gas. As an example, samplings of combustion air composition may be acquired over a particular period of time (e.g., approximately 10-minute period, etc.) at a desirable polling rate (e.g., approximately 1 Hz) where a workflow may generate an average that may be applied in one or more subsequent determinations for a given source. Exhaust gas composition, on the other hand, may be measured for an hour or such lesser or greater time as deemed appropriate to adequately characterize cyclical and/or other variations in flue gas composition (e.g., due to load variations or application of control of a combustion source).

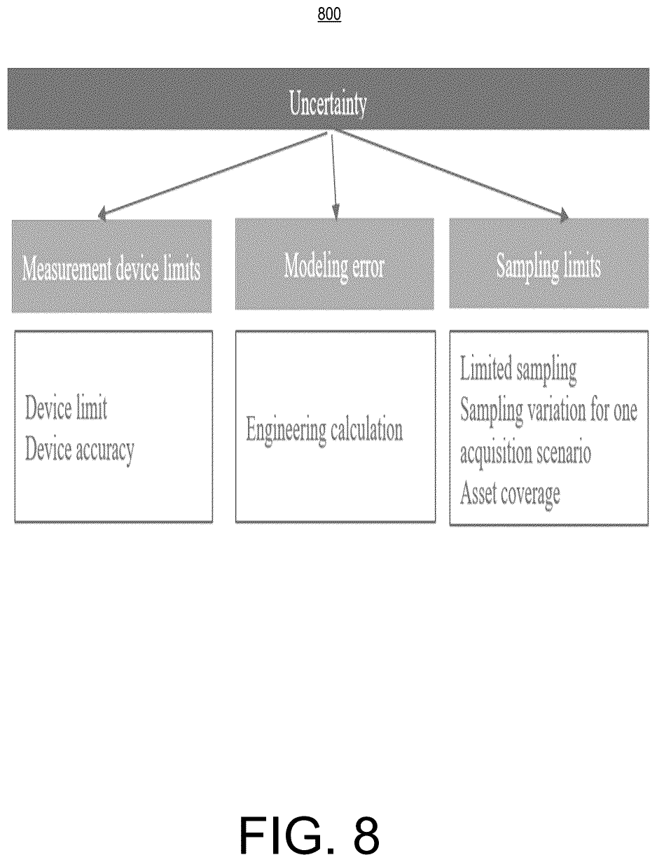

FIG. 8 shows an example workflow 800 that may be implemented by a system as to uncertainty, for example, as part of uncertainty data processing. As to uncertainty in emissions estimation, consider sources that may have an impact such as measurement device limits, modeling error, and sampling error.

Assessments as to uncertainty may provide for improved monitoring, control, design, feedback, data acquisition, sensor utilization, sensor deployment, satellite selection and/or programming, etc. As explained, a focus has been placed on reporting total emissions as a metric. This metric alone may be wide ranging in its uncertainty and may be in need of improvement or not. Assessments of uncertainty may help to identify where improvements may be warranted, where metric values are potentially erroneous, where metric values may be subject to factors such as, for example, weather, sensor availability, sensor operation, etc. Uncertainty assessments may provide an understanding of confidence in emissions reporting (e.g., static, dynamic, etc.), may provide a basis for reconciliation of bottom up and top-down measurements, may provide a quantitative understanding of impacts of one or more of spatial and temporal variabilities on emissions, may provide for an understanding of impact of representative sampling on reported emissions, etc. As an example, a framework may provide for implementation of workflows that may combine emissions reporting with uncertainty estimation, which may account for one or more forms of uncertainty associated with emissions reporting.

As to device limits, measurements acquired during surveys may be subject to measurement error based on factors such as, for example, accuracy and the upper and bottom limits of instruments used for measurement. As to modeling errors, consider computation of stationary combustion device emissions and operational data such as fuel/flare gas volumes and vented volumes that may be subject to modeling error. As to sampling errors, such error may reflect the difference in characteristics of a sample relative to a population. For example, if 100 flanges are sampled out of a population of 1000, the characteristics of this sample of 100 flanges may be an approximation of characteristics of the population; however, it may be different from “true” characteristics of the population. As an example, sampling error may be computed by dividing standard deviation of a population by the square root of the size of a sample and then multiplying the resultant with the Z-score value, which may be based on confidence interval. For example, for a 95% confidence interval (CI) and based on an assumption that emissions are normally distributed, sampling error may be estimated using a sampling error equation such as:

$$Sampling error = Z \times \frac{SD}{√ n}$$

where, Z is the z-score (e.g., 2 for a 95% CI), SD is the standard deviation (of measurements conducted across different sources), and n is the sample size.

As an example, measurement error associated with sampling may depend on instrument accuracy and may be summarized in Table 1, below.

TABLE 1
Errors and Uncertainties

| Source | Measurement error | Modeling error | Sampling error |
|---|---|---|---|
| Fugitive EF | Accuracy of HFS | None | Depends on the sample |
| | | | size and SD |
| Stationary | Accuracy of the used | Uncertainty in | Depends on the sample |
| Combustion | flow rate, and the | modeling output | size and SD |
| | flow composition | | |
| | gauging devices | | |
| Flare CE | Accuracy of Mantis | None | Depends on the sample |
| | camera | | size and SD |
| Routine Vented | Accuracy of HFS, | None | Depends on the sample |
| | QOGI, OGI | | size and SD |
| Operational data | Meter accuracy | Uncertainty | Not applicable for these |
| (fuel/flare volumes, | | associated with | assets |
| vent volumes, gas | | mass | |
| composition) | | balance/modeling | |

As an example, uncertainty computations may be performed in stages. For example, consider an approach that involves an uncertainty computation stage for uncertainty computation at source level (e.g., fugitives, flares, stationary combustion, routine and other vented), and the addition of uncertainty sources in the same category; an expanded stage for expanded uncertainty factor (K-Factor) computation at a facility level; and a combined stage for combining various source category uncertainties at a country level (e.g., or other region level).

As an example, as to uncertainty at source level, consider, for each emission category (e.g., flares, venting, etc.), uncertainty integration may be based on a first order Taylor series approximation. With an assumption that AFs and EFs are independent of each other, consider the following equation:

$${U}_{sc} = \sqrt{{EF}^{2} \times {Error}_{AF}^{2} + {AF}^{2} \times {Error}_{EF}^{2}}$$

As an example, one or more techniques may be utilized to integrate uncertainty at a facility level, which may include use of the root sum of squares (RSS) technique.

As an example, for independent uncertainties, a combined uncertainty (U) may be computed as follows:

$${U}_{fl} = \sqrt{[ ( {U}_{sc - 1}^{2} ) + ( {U}_{sc - 2}^{2} ) + ⋯ + ( {U}_{sc - i}^{2} ) + ⋯ ( {U}_{sc - n}^{2} ) ]}$$

where, U_{sc_i} is the individual uncertainties related to the emission subcategories and U_{fl} is the combined uncertainty at facility level.

As to an expanded uncertainty factor (K-Factor) computation at source level and facility level, consider, as an example, use of expanded uncertainty factor to account for one or more undefined areas of emissions computations (e.g., uncertainty related to sampling, time of measurement compared to full year operation, uncertainty in the activity factors, etc.). As an example, consider the following equation:

$${U}_{expand} = {kU}_{fl} ( y )$$

where, y is the estimate of measurement and Y is a result of a measurement, output estimate, U_{fl}(y) is the uncertainty of y, on facility level, U_{expand} is the expanded uncertainty, and k is the expanded uncertainty factor.

As an example, to estimate the expanded uncertainty factor, consider an approach that may use a few parameters that mostly impact emissions uncertainty computations that may be covered by an expanded uncertainty factor, which may include, for example, gas to oil ratio, production or AF confidence, local regulation framework, combined materiality of flares and vents over the total facility emissions at Level 3, direct measurement or extrapolation, weather, etc.

For example, gas to oil ratio may be a parameter that allows facilities to be classified by predominant type of produced hydrocarbon. As an example, a facility where a main product is natural gas may expect lower emissions of methane. As another example, a facility with a distribution close to 50% gas and 50% other hydrocarbons, may also expect better use of methane. In the case of facilities where the main product is oil, and methane gas is an associated hydrocarbon, there may be a policy of prioritizing oil production where gas is an additional product of little value compared to oil and, therefore, there may be probability-wise, a higher gas emission rate.

As to a production or AF confidence, consider a qualitative analysis in confidence and accuracy of AFs, where variability of production/processing, and accuracy of gas compositions, flow rates, annual throughputs, etc., may be taken into account.

As to a local regulation framework, consider one or more of a national and regional methane emissions regulatory framework, which may be drivers to reduce emissions. As an example, strong and enforced emissions regulation may be another factor to qualify uncertainty of Level 4 emissions reporting, monitoring, control, etc.

As an example, combined materiality of flares and vents over the total facility emissions at Level 3 may be considered. In various instances, the biggest emission sources in the upstream sector may be routine vents and flaring. Hence, this may be a relevant performance indicator that may be used to understand how uncertainties related to flaring and venting may be material as sources for a facility. In case of high materiality of flaring and venting sources, uncertainty related to operational conditions, gas composition variabilities, and weather induced variability may be considered using the K factor.

As an example, direct measurement or extrapolation may be utilized. For example, such a qualitative approach may be able to consider uncertainty related to direct measurements and/or emissions quantification through extrapolation. As an example, uncertainty may be lower if sources were directly measured and larger if the emission factors were extrapolated to a facility, for example, from one or more similar facilities (e.g., pertaining to the same asset, etc.).

As to weather, it may have one or more types of impacts. As an example, weather data as to one or more of temperature, humidity, wind speed, and direction, etc. may impact emissions readings and/or dispersion patterns.

TABLE 2
Example evaluations and scenarios.

| | | | | % flare | | |
|---|---|---|---|---|---|---|
| | | Production or | | and vent | | |
| Expanded | Gas Oil Ratio | Activity | Local | emission | | Weather & |
| Uncertainty | (Mboe/Mboe) | Factor | regulation | over total | | Environment |
| Scenario | & Category | Confidence | framework | emission L3 | Technique | impact |
| Best case scenario | 0.75 (Best) | Facility | Strong and | 30% | Direct | Wind <2 m/s; |
| where all parameters | | fully/well | enhanced | | measure of | Temperature >0 |
| allow to keep low | | documented | local | | sources | is favorable |
| value for extended | | and complete | environ. | | emissions | for measures |
| uncertainty | | inventory | regulation | | | |
| Intermediate case | 0.4 to 0.75 | intermediate | Interm. | 30% to | Combined | Wind |
| scenario | (Average) | | | 50% | measure and | between 2 m/s |
| | | | | | extrapolated | and 6 m/s; |
| | | | | | approach | temperature |
| | | | | | | between |
| | | | | | | 0-−15° C. |
| Worst case scenario | 0.4 (Worse) | Facility poor | Weak or | 50% | Fully | Wind >6 m/s; |
| where all parameters | | documented | poor local | | extrapolate/ | Temperature <−15° |
| increase the | | and | environ. | | simulated | C. is not |
| extended | | incomplete | regulation | | approach | favorable for |
| uncertainty value | | inventory | | | | measures |

TABLE 3
K Factor Value by Evaluation Criteria

| | | | | | % flare | | | |
|---|---|---|---|---|---|---|---|---|
| | | Gas | Production | | and vent | | | |
| Expanded | | Oil | or Activity | | emission | | | |
| Uncertainty | Category | Ratio | Factor | Local | over total | | Weather | |
| Scenario | Descript. | factor | Confid. | reg. FW | emiss. L3 | Technique | Impact | Total |
| Best case scenario | Best | 1.10 | 1.10 | 1.10 | 1.25 | 1.20 | 1.1 | |
| where all | | | | | | | | |
| parameters allow to | | | | | | | | |
| keep low value for | | | | | | | | |
| extended | | | | | | | | |
| uncertainty | | | | | | | | |
| Intermediate case | Mean | 1.50 | 1.50 | 1.50 | 1.50 | 1.50 | 1.5 | |
| scenario | | | | | | | | |
| Worst case | Worst | 2.00 | 2.00 | 2.00 | 2.00 | 2.00 | 2 | |
| scenario where all | | | | | | | | |
| parameters | | | | | | | | |
| increase the | | | | | | | | |
| extended | | | | | | | | |
| uncertainty value | | | | | | | | |
| | Weight (%) | 20% | 15% | 20% | 15% | 22% | 8% | 100% |

As an example, a K-Factor computation may be based on survey and sum-product of multiple categories, for example, as shown in Table 3, above. In the worst case, an expanded factor may be 100%, which means double the uncertainty computed previously.

As an example for weather impact, one or more data acquisition and processing workflows may be utilized. As an example, data may be accessed from one or more public sources (e.g., ERA5 from ClimateDataStore, etc.). As an example, temperature data may be averaged with weather input from measurements.

As an example, as to wind, wind variables may be computed using a 10-m eastward (U10M) and northward (V10M) wind speed (m/s) components. As an example, a positive U wind component may be parallel to a positive x-axis (West to East), while a positive V component may be parallel to a positive y-axis (South to North).

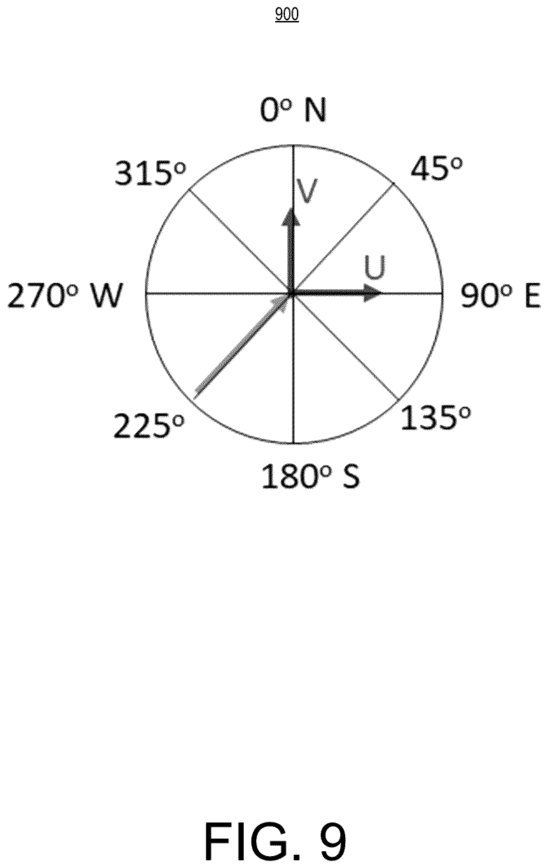

FIG. 9 shows an example schematic of a convention for consideration of wind. For example, consider MERRA-2 northward (V) and eastward (U) components of winds. As explained, average wind speed parameters may be computed using the following example equation:

$$Average wind speed = \sqrt{{U}^{2} + {V}^{2}}$$

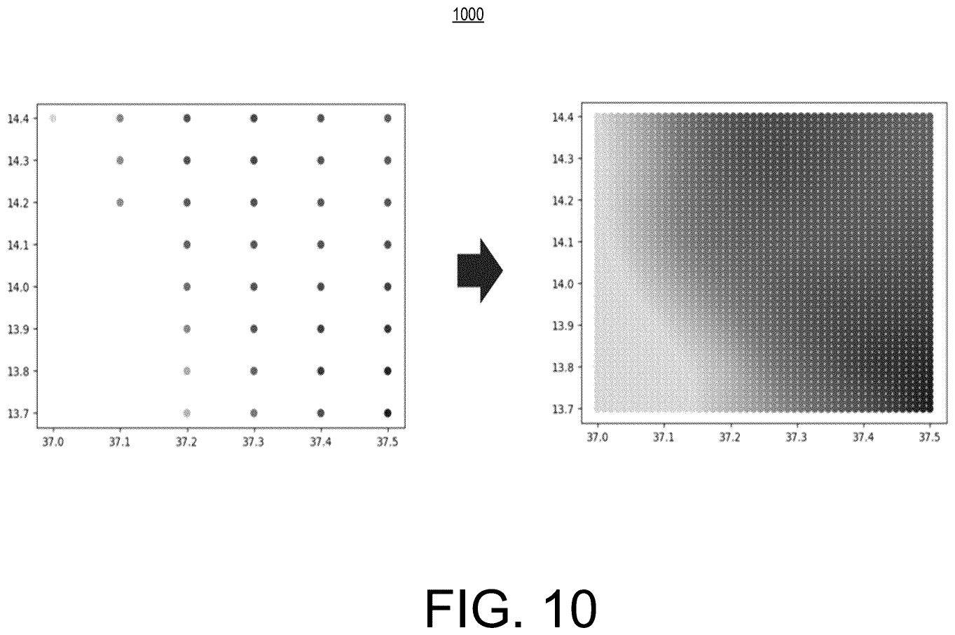

FIG. 10 shows an example of a multidimensional approach 1000 for wind speed interpolation and extrapolation. As an example, data utilized may be or include ERA5 Land Hourly data (with 0.1 GPS coordinate precision, 9 km resolution). To compute accurate wind speed for a facility location, a 2-dimensional interpolation and extrapolation may be performed, for example, as indicated in FIG. 10.

As to temperature data, it may be proceeded with logic that may be applied for wind data, for example, consider multidimensional interpolation and extrapolation (e.g., 2-dimensional interpolation and extrapolation), which may provide a more accurate temperature map for a facility location. As temperature data may also be in measurement records, a final temperature value may be equally weighted between ERA5 value and recorded value. As an example, in case of missing temperature records, an ERA5 value may be used.

As an example, as to expanded uncertainty factor (K-Factor) computation at a region level (e.g., country level, etc.), consider using a statistical approach as mentioned for source/facility level. As an example, expanded uncertainty may be computed for each measured facility.

$${U}_{country} = \sqrt{[ ( {U}_{fl - 1}^{2} ) + ( {U}_{fl - 2}^{2} ) + ⋯ + ( {U}_{fl - i}^{2} ) + ⋯ ( {U}_{fl - n}^{2} ) ]}$$

As an example, a system may provide for implementation of a methane emissions quantification and uncertainty estimation workflow. In such an example, the system may generate a user interface to input data and documentation, select relevant parameters, acquire and/or store real-time data, structured data, unstructured data, public data, etc. Such a system may provide for preprocessing, consolidating and standardizing acquired data. As an example, a system may provide for quantifying a methane emission rate for one or more of fugitive emissions, flaring emissions, stationary combustion emissions, routine vented emissions and other vented emissions. As an example, a system may provide for estimating uncertainty with different sources of uncertainty, for example, combining different factors and on different levels. As an example, a system may provide for generating an emission result form/report and associated visualization. As an example, a system may provide for issuing one or more types of control instructions, which may be for control of field equipment. For example, consider control instructions for acquiring measurements, ascertaining uncertainty, reducing uncertainty, mitigating emissions, etc.

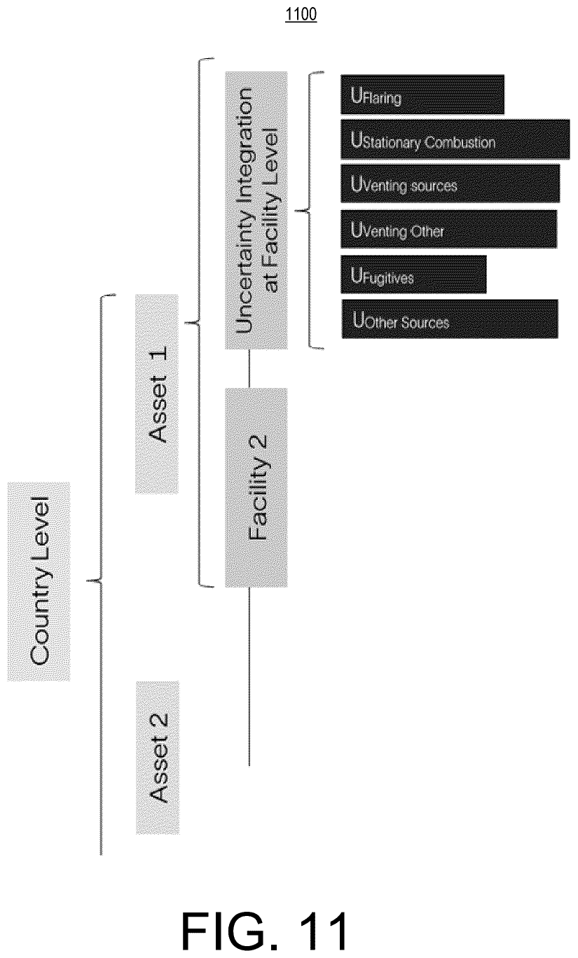

FIG. 11 shows an example graphic 1100 that includes a hierarchy as to various characterizations of facilities, which may be for a region. As shown, various types of uncertainty may be determined for a facility, where, for example, uncertainties may be aggregated and/or otherwise taken into account for an asset, a region, etc. In such an approach, a hierarchy may provide for identifying one or more facilities that may benefit from one or more actions. For example, consider a system that may issue one or more control instructions to control one or more sensors to acquire data, which may provide for assessing uncertainty, which may provide for reducing uncertainty and/or identifying one or more particular sources of uncertainty (e.g., a faulty sensor, a faulty transmission line, a problematic component, etc.).

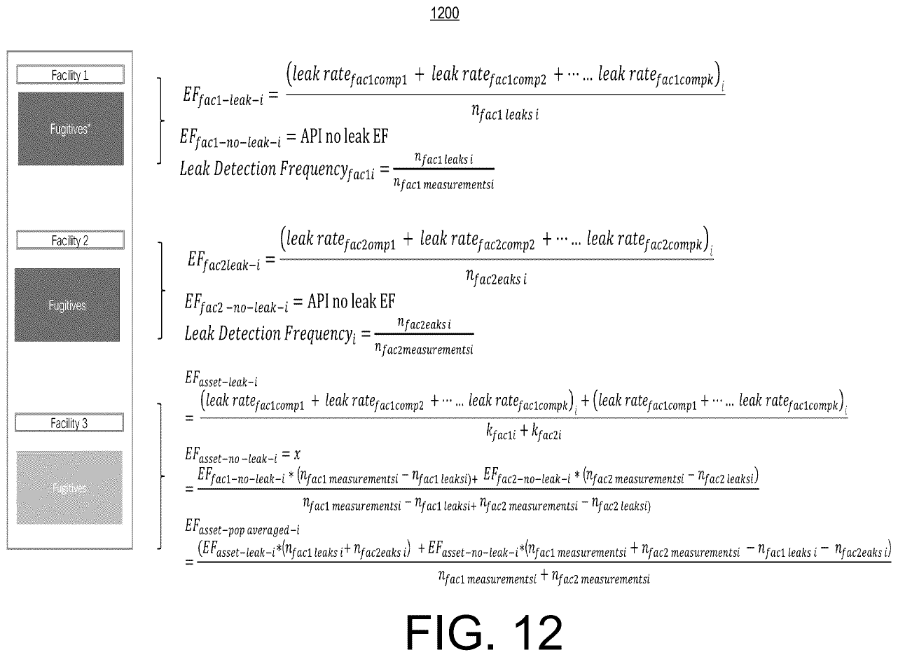

FIG. 12 shows an example of a workflow 1200 for fugitive emissions. For example, consider an approach where EFs are computed per fugitive component type per service type in each of a number of facilities. In such an example, for facilities where direct measurements are conducted, a system may provide for averaging leaking EFs to be computed based at least in part on observed emission rates. As an example, where direct measurements are unavailable for one or more facilities, an asset specific population averaged EFs may be utilized. As an example, an updated methane emissions rate may be equal to a default methane emissions rate multiplied by an updated methane content and/or default methane content value.

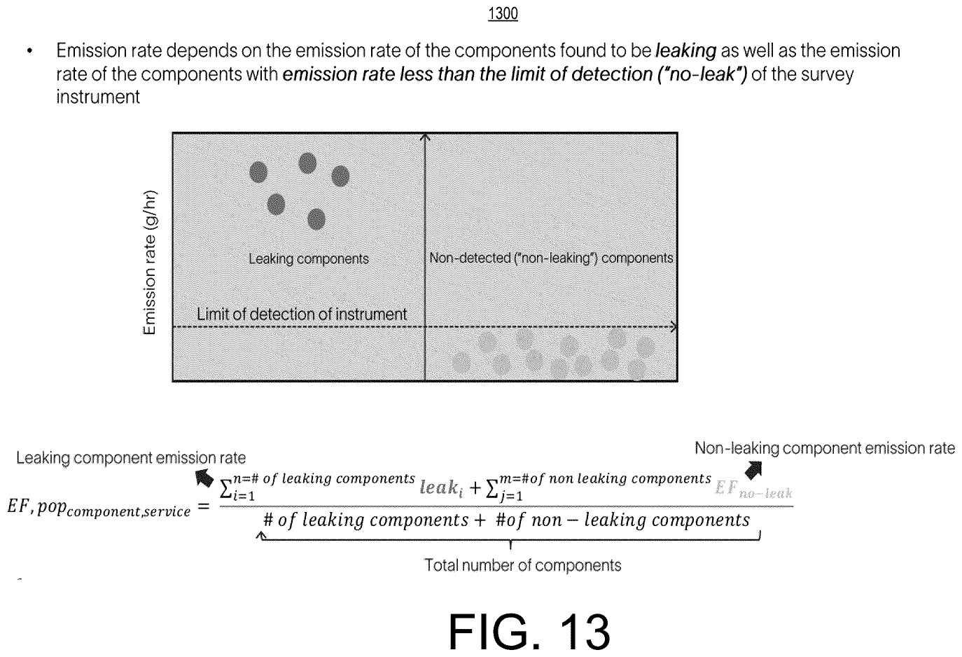

FIG. 13 shows an example of a workflow 1300 for fugitive EF computation. As shown, an emission rate may depend on the emission rate of components found to be leaking as well as emission rate of components with emission rate less than a limit of detection (e.g., no-leak) of a survey instrument. As explained, one or more pieces of equipment may be controlled based on a result from a workflow where the workflow may provide for issuance of one or more control instructions that aim to control, mitigate, etc., emissions. As explained, a system may provide for control of one or more sensors. For example, if a limit of detection may be desired to be lowered, a control instruction may provide for use of one or more instruments that may provide for a lower limit of detection. For example, consider navigating a drone to a site where the drone is equipped with one or more sensors (e.g., integral or as payload). As an example, a drone-based system may provide for selecting a sensor type or sensor types and outfitting a drone or drones with one or more sensors, as selected, to then be navigated to a particular site or particular sites to acquire data. In such an example, uncertainty may be reduced, which, in turn, may provide for improved decision-making, for example, as to control of equipment at a facility to reduce emissions and/or otherwise beneficially manage emissions.

As an example, a system, a computational framework, etc., may include and/or execute within a gateway such as, for example, an AGORA gateway (e.g., consider one or more processors, memory, etc., which may be deployed as a “box” that can be locally powered and that can communicate locally with other equipment via one or more interfaces). As an example, one or more pieces of equipment may include computational resources that can be akin to those of an AGORA gateway or more or less than those of an AGORA gateway. As an example, an AGORA gateway may be a network device with various networking capabilities.

As an example, a gateway can include one or more features of an AGORA gateway (e.g., v.202, v.402, etc.) and/or another gateway. For example, consider features such as an INTEL ATOM E3930 or E3950 dual core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS or another operating system). As an example, a gateway may include a cellular interface (e.g., 4G LTE with global modem/GPS, 5G, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in (e.g., 25 cm×20.3 cm×10.1 cm).

As an example, a gateway can include features that enhance its operation at a remote site that may be distant from a city, a town, etc., such that travel to the site and/or communication with equipment at the site is problematic and/or costly. As an example, a gateway may be onshore or offshore. As an example, a gateway can include an operating system and memory that can store one or more types of applications that may be executable in an operating system environment. Such applications can include one or more security applications, one or more control applications, one or more simulation applications, one or more ML model-based applications, etc.

As an example, various types of data may be available, for example, consider real-time data from equipment and ad hoc data. In various examples, data from sources connected to a gateway may be real-time, ad hoc data, sporadic data, etc. As an example, data may be available that can be used to fine tune one or more models (e.g., locally, etc.). As an example, data from a framework such as the AVOCET framework may be utilized where results and/or data thereof can be sent to the edge. As an example, one or more types of ad hoc data may be stored in a database and sent to the edge.

As an example, a computational framework may be implemented using one or more computational devices, systems, etc., which may be operatively coupled via one or more networks (e.g., wired, wireless, etc.). As an example, one or more application programming interfaces (APIs) may be utilized where, for example, a call may be made according to an API where, in response, information is received. For example, consider one or more local and/or remote resources that may provide for use of one or more models that can be called according to one or more APIs. As an example, one or more APIs may be utilized to acquire data, control instructions, etc. As an example, a framework may be implemented using local and/or remote resources where, for example, local resources may include one or more types of edge devices installed locally at a wellsite for one or more wells. As an example, a framework may be implemented using one or more types of circuitry, which may include, for example, embedded circuitry. For example, consider embedding one or more components of a framework in a device, which may be a downhole device or a surface device.

As an example, a system, a method, etc., may utilize one or more machine learning features, which can be implemented using one or more machine learning models. As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, CATBoost, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, a system may utilize one or more recurrent neural networks (RNNs). One type of RNN is referred to as long short-term memory (LSTM), which can be a unit or component (e.g., of one or more units) that can be in a layer or layers. A LSTM component can be a type of artificial neural network (ANN) designed to recognize patterns in sequences of data, such as time series data. When provided with time series data, LSTMs take time and sequence into account such that an LSTM can include a temporal dimension. For example, consider utilization of one or more RNNs for processing temporal data from one or more sources, optionally in combination with spatial data. Such an approach may recognize temporal patterns, which may be utilized for making predictions (e.g., as to a pattern or patterns for future times, etc.).

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device and/or distributed devices may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). TFL can provide multiple platform support, covering ANDROID and iOS devices, embedded LINUX, and microcontrollers. TFL can provide diverse language support, which includes JAVA, SWIFT, Objective-C, C++, and PYTHON. TFL can provide high performance, with hardware acceleration and model optimization.

As an example, a system may utilize one or more ML models. For example, consider one or more ML models that may be utilized for predicting leaks. In such an example, an ML model may be trained using data from a number of facilities. In such an example, an ML model may generate output that may be utilized to improve resource utilization with acceptable quantification of emissions, determination of uncertainty, etc. For example, consider a virtual sensor approach where a ML model-based output may provide for supplementing measurement data, supplanting measurement data, assessing measurement data (e.g., as to errors, etc.). As an example, an ML model-based approach may provide for making one or more predictions as to one or more environmental conditions. For example, consider weather as a type of environmental condition or conditions. As an example, an ML model may provide for predicting probability of a leak. For example, consider an ML model that may be a digital twin of one or more equipment components that may provide for characterizing actual equipment under one or more conditions (e.g., flow, weather, age, etc.).

### Example Method and System

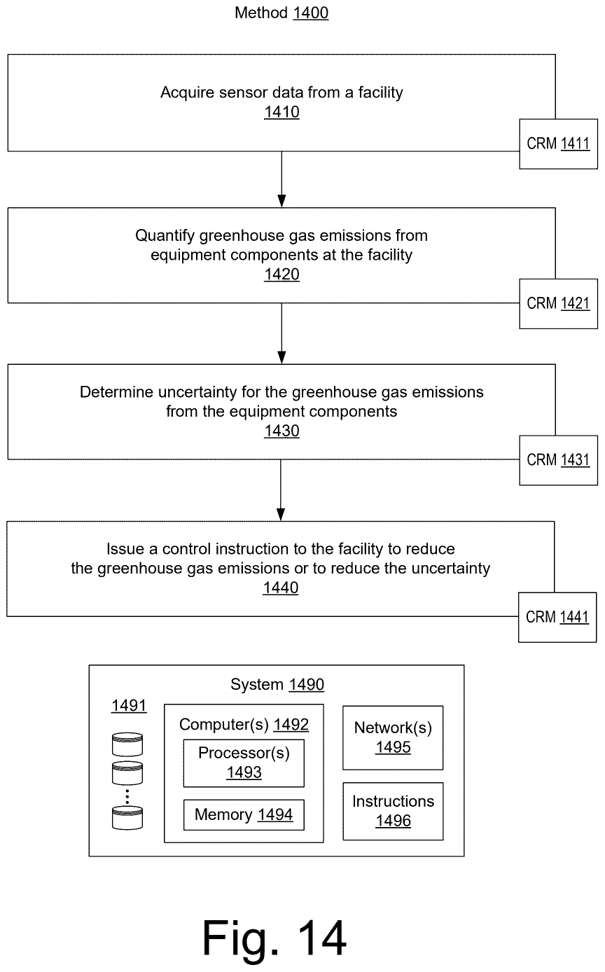

FIG. 14 shows an example of a method 1400 and an example of a system 1490. As shown, the method 1400 can include an acquisition block 1410 for acquiring sensor data from a facility; a quantification block 1420 for quantifying greenhouse gas emissions from equipment components at the facility; a determination block 1430 for determining uncertainty for the greenhouse gas emissions from the equipment components; and an issuance block 1440 for issuing a control instruction to the facility to reduce the greenhouse gas emissions or to reduce the uncertainty.

The method 1400 is shown in FIG. 14 in association with various computer-readable media (CRM) blocks 1411, 1421, 1431, and 1441. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 1400. As an example, a computer-readable medium (CRM) may be a computer-readable storage medium that is non-transitory and that is not a carrier wave. As an example, one or more of the blocks 1411, 1421, 1431, and 1441 may be in the form of processor-executable instructions.

In the example of FIG. 14, the system 1490, which may be a wellsite system, can include one or more information storage devices 1491, one or more computers 1492, one or more networks 1495 and instructions 1496. As to the one or more computers 1492, each computer may include one or more processors (e.g., or processing cores) 1493 and memory 1494 for storing the instructions 1496, for example, executable by at least one of the one or more processors 1493 (see, e.g., the blocks 1411, 1421, 1431, and 1441). As an example, a computer may include one or more network interfaces (e.g., wired or wireless), one or more graphics cards, a display interface (e.g., wired or wireless), etc.

As an example, a method may include acquiring sensor data from a facility; quantifying greenhouse gas emissions from equipment components at the facility; determining uncertainty for the greenhouse gas emissions from the equipment components; and issuing a control instruction to the facility to reduce the greenhouse gas emissions or to reduce the uncertainty. In such an example, the facility may be an oil and gas facility.

As an example, a method may include quantifying that includes determining that one of a number of equipment components is leaking or not leaking in view of a sensor detection limit. In such an example, the sensor detection limit may correspond to a gas detector. As an example, a gas detector may be one or more of a hi-flow detector or an optical gas imaging detector.

As an example, a control instruction may be an instruction to reduce uncertainty by acquiring sensor data, which may include installation of a sensor, control of a sensor as to sampling rate, accuracy (e.g., analog to digital converter operation, etc.), etc., programming of a satellite, etc.

As an example, a control instruction may be an instruction to reduce greenhouse gas emissions by adjusting a valve.

As an example, a method may include determining uncertainty in a manner that includes utilizing one or more measurement device limits.

As an example, a method may include determining uncertainty in a manner that includes utilizing modeling error for one or more emissions models.

As an example, a method may include determining uncertainty in a manner that includes utilizing one or more sampling limits.

As an example, a method may include identifying one of a number of equipment components as a largest greenhouse gas emitter. For example, consider a method that includes identifying in a manner that includes utilizing a determined uncertainty for greenhouse gas emissions for one of a number of equipment components.

As an example, a method may include identifying one of a number of equipment components as associated with a largest uncertainty.

As an example, a method may include aggregating greenhouse gas emissions for a facility with greenhouse gas emissions for one or more other facilities. In such an example, the facilities may be within a region.

As an example, a method may include comparing a quantified amount of greenhouse gas emissions to a greenhouse gas emissions threshold. In such an example, the method may include, responsive to the comparing, transmitting the quantified amount of greenhouse gas emissions and the determined uncertainty via a network to a network address. In such an example, the network address may be for an authority (e.g., a regulatory authority), a controller operatively coupled to a network, one or more field sites (e.g., for informing how to operate equipment in a field at one or more field sites), etc. As an example, a method may include comparing quantified greenhouse gas emissions to one or more greenhouse gas emissions thresholds.

As an example, a method may provide for quantifying greenhouse gas emissions where the greenhouse gas emissions include methane gas.

As an example, a system may include a processor; a memory accessible to the processor; and processor-executable instructions stored in the memory to instruct the system to: acquire sensor data from a facility; quantify greenhouse gas emissions from equipment components at the facility; determine uncertainty for the greenhouse gas emissions from the equipment components; and issue a control instruction to the facility to reduce the greenhouse gas emissions or to reduce the uncertainty. In such an example, a control loop may be established, which may be a feedback control loop. For example, consider a controller or control system that may be locally installed, remotely installed, distributed locally and remotely, etc., where sensor data may be received and control instructions issued to control field equipment.

As an example, one or more computer-readable storage media may include processor-executable instructions to instruct a wellsite computing system to: acquire sensor data from a facility; quantify greenhouse gas emissions from equipment components at the facility; determine uncertainty for the greenhouse gas emissions from the equipment components; and issue a control instruction to the facility to reduce the greenhouse gas emissions or to reduce the uncertainty. In such an example, the wellsite computing system may be local, remote, local and remote, etc. As an example, a wellsite computing system may include one or more controllers that may be operatively coupled to field equipment, which may be at a wellsite, wellsites, etc. As an example, a wellsite computing system may provide for control of equipment at one or more wellsites, for example, in a coordinated manner for purposes of emissions control, uncertainty control, emissions and uncertainty control, etc.

As an example, a computer program product can include one or more computer-readable storage media that can include processor-executable instructions to instruct a computing system to perform one or more methods and/or one or more portions of a method. Various example methods may be performed in various combinations.

### Example System

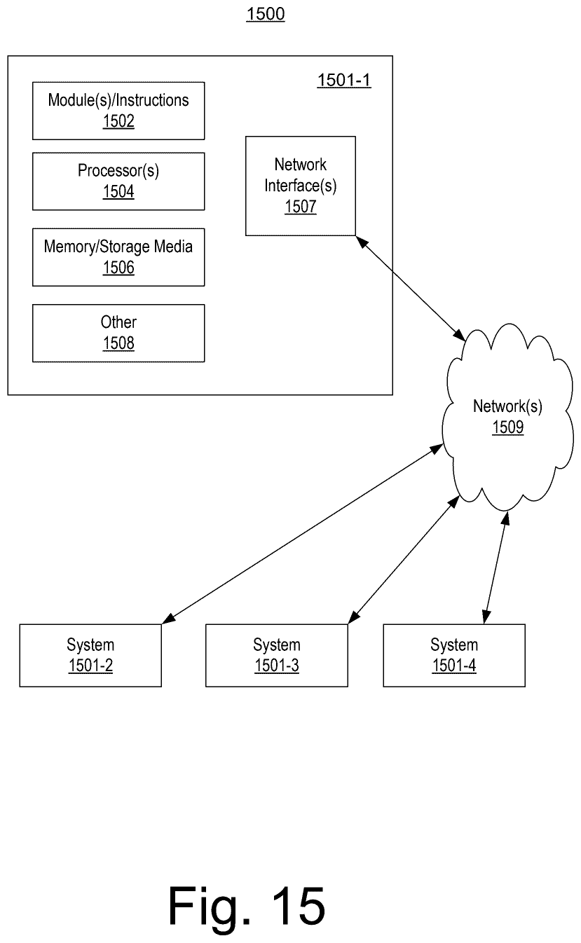

In some embodiments, a method or methods may be executed by a computing system. FIG. 15 shows an example of a system 1500 that can include one or more computing systems 1501-1, 1501-2, 1501-3, and 1501-4, which may be operatively coupled via one or more networks 1509, which may include wired and/or wireless networks. As shown, the system 1500 can include one or more other components 1508.

As an example, a system can include an individual computer system or an arrangement of distributed computer systems. In the example of FIG. 15, the computer system 1501-1 can include one or more modules 1502, which may be or include processor-executable instructions, for example, executable to perform various tasks (e.g., receiving information, requesting information, processing information, simulation, outputting information, etc.).

As an example, a module may be executed independently, or in coordination with, one or more processors 1504, which is (or are) operatively coupled to one or more storage media 1506 (e.g., via wire, wirelessly, etc.). As an example, one or more of the one or more processors 1504 can be operatively coupled to at least one of one or more network interface 1507. In such an example, the computer system 1501-1 can transmit and/or receive information, for example, via the one or more networks 1509 (e.g., consider one or more of the Internet, a private network, a cellular network, a satellite network, etc.).

As an example, the computer system 1501-1 may receive from and/or transmit information to one or more other devices, which may be or include, for example, one or more of the computer systems 1501-2, etc. A device may be located in a physical location that differs from that of the computer system 1501-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1506 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
acquiring sensor data from a facility;
quantifying greenhouse gas emissions from equipment components at the facility;
determining uncertainty for the greenhouse gas emissions from the equipment components; and
issuing a control instruction to the facility to reduce the greenhouse gas emissions or to reduce the uncertainty.

2. The method of claim 1, wherein the facility comprises an oil and gas facility.

3. The method of claim 1, wherein quantifying comprises determining that one of the equipment components is leaking or not leaking in view of a sensor detection limit.

4. The method of claim 3, wherein the sensor detection limit corresponds to a gas detector.

5. The method of claim 4, wherein the gas detector comprises a hi-flow detector or an optical gas imaging detector.

6. The method of claim 1, wherein the control instruction is to reduce the uncertainty by acquiring sensor data.

7. The method of claim 1, wherein the control instruction is to reduce the greenhouse gas emissions by adjusting a valve.

8. The method of claim 1, wherein determining uncertainty comprises utilizing one or more measurement device limits.

9. The method of claim 1, wherein determining uncertainty comprises utilizing modeling error for one or more emissions models.

10. The method of claim 1, wherein determining uncertainty comprises utilizing one or more sampling limits.

11. The method of claim 1, comprising identifying one of the equipment components as a largest greenhouse gas emitter.

12. The method of claim 11, wherein the identifying comprises utilizing a determined uncertainty for the greenhouse gas emissions for the one of the equipment components.

13. The method of claim 1, comprising identifying one of the equipment components as associated with a largest uncertainty.

14. The method of claim 1, comprising aggregating the greenhouse gas emissions for the facility with greenhouse gas emissions for one or more other facilities.

15. The method of claim 14, wherein the facilities are within a region.

16. The method of claim 1, comprising comparing the quantified greenhouse gas emissions to a greenhouse gas emissions threshold.

17. The method of claim 16, comprising responsive to the comparing, transmitting the quantified greenhouse gas emissions and the determined uncertainty via a network to a network address.

18. The method of claim 1, wherein the greenhouse gas is methane gas.

19. A system comprising:
a processor;
a memory accessible to the processor; and
processor-executable instructions stored in the memory to instruct the system to:
acquire sensor data from a facility;
quantify greenhouse gas emissions from equipment components at the facility;
determine uncertainty for the greenhouse gas emissions from the equipment components; and
issue a control instruction to the facility to reduce the greenhouse gas emissions or to reduce the uncertainty.

20. One or more computer-readable storage media comprising processor-executable instructions to instruct a wellsite computing system to:
acquire sensor data from a facility;
quantify greenhouse gas emissions from equipment components at the facility;
determine uncertainty for the greenhouse gas emissions from the equipment components; and
issue a control instruction to the facility to reduce the greenhouse gas emissions or to reduce the uncertainty.
